(19) United States
(12) Patent Application Publication
(10) Pub. No.: US 2003/0129488 A1
(43) Pub. Date: Jul. 10, 2003

(54) Planar battery and method of sealing

(76) Inventor: Oliver J. Gross, Round Aock, TX (US)

Correspondence Address: VALENCE TECHNOLOGY, INC., 301 CONESTOGA WAY, HENDERSON, NV, 89015, US

(21) Appl. No.: 10/042,981

(22) Filed: Jan. 9, 2002

(51) Int. Cl. H01M 2/08; H01M 10/04

(52) U.S. Cl. 429/185; 429/176; 29/623.2

(57) ABSTRACT

A method of sealing a planar battery having a sachet-type packaging to thereby reduce unused volume in a headspace portion is provided. A headspace seal flange is folded at an acute angle at about the middle of the flange. The headspace seal flange may be folded about in half and upon itself, with the folded headspace seal flange adjacent to a top of the planar battery.

### FIELD OF THE INVENTION

The present invention relates generally to electrochemical cells and batteries, and more particularly to a method of folding a headspace portion of a planar battery to reduce unused volume.

### BACKGROUND OF THE INVENTION

The increased use of mobile electronic devices, and in particular to such devices having smaller casings (e.g., Personal Digital Assistants (PDAs) and cellular telephones), to perform everyday tasks, has resulted in a need to provide smaller and more powerful batteries for use in these devices. Because of the limited space within the devices, design tolerances are very tight, thereby requiring that the component parts, including the batteries for providing power, to be manufactured within very narrow specification limits. It is extremely important that these batteries are packaged (i.e., encased) to minimize unused space (i.e., make the battery more compact) while maintaining acceptable performance levels.

In particular, the manufacture of planar batteries, including, for example, lithium ion batteries has allowed the use of different configurations and sizes of batteries for powering devices (e.g., portable personal communication devices) in many different applications not previously possible. In many of these applications (e.g., cellular telephones) it is important to provide a space saving battery that allows flexibility in design. For example, some applications will require a battery having a narrow footprint with tight design tolerances. It is often critical to manufacture these batteries such that the overall size of the packaged battery is as compact as possible (e.g., minimize overall length of packaged battery), and in particular, that unused space within the packaged battery is minimized (e.g., reduce the amount of unused volume at the headspace of a sachet-packaged planar battery).

It is known to use sachet-packaging to seal a planar battery. When encasing a cell in a sachet-type packaging, a headspace portion is needed in order to guide the two top edges of the package material and control their alignment. The volume of the headspace portion is unused and reduces the energy density of the battery. Generally, excess packaging material at the headspace portion of the battery results when a cell is inserted within the packaging material (e.g., foil pouch), which also increases the overall length of the battery.

### SUMMARY OF THE INVENTION

It will become apparent from the disadvantages of the prior art that a need exists for a method of sealing a planar battery (e.g., lithium ion battery) to reduce the amount of unused headspace volume and decrease the overall length of a packaged battery. It is desirable to reduce this unused volume to increase the energy density of the battery.

The present invention provides a method for reducing the headspace portion of a sachet-packaged planar battery, and in particular, folding a seal at the headspace portion to reduce the amount of unused volume at the headspace portion. Specifically, a method of folding a battery packaging according to the principles of the present invention wherein the battery packaging has an edge seal formed when sealing a battery therein includes folding the edge seal of a headspace portion of the battery packaging (e.g., sachet-type foil packaging) such that the edge seal is folded generally at the middle of the headspace. The edge seal is preferably folded upon itself at an acute angle relative to the battery. Preferably, the headspace is folded generally in half.

A battery having a sachet packaging of the present invention includes a cell within the sachet packaging for providing power to an external load, and a top portion of the sachet packaging having a folded headspace seal flange configured in an acute angle relative to the top portion. The planar battery may comprise different types of cells, including, for example, a lithium ion polymer cell. The folded headspace is preferably folded in half upon itself.

The present invention also provides an improved sealing arrangement for a planar battery (e.g., lithium ion cell) having a sachet packaging that includes a folded seal portion at a headspace portion of the planar battery, with the folded seal portion configured at a generally acute angle relative to a top of the battery.

Thus, the present invention provides a method of sealing a planar battery having a sachet-type packaging using a folded seal at a headspace portion of the battery. Unused volume of the battery is reduced and overall battery length decreased.

Further areas of applicability of the present invention will become apparent from the detailed description of the preferred embodiments, claims and accompanying drawings provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top perspective view of a typical planar battery with the peripheral seal in an unfolded configuration;

FIG. 2 is a cross-sectional view of the typical planar battery of FIG. 1 taken along the line 2-2;

FIG. 3(a) is a top plan view of another typical planar battery;

FIG. 3(b) is a cross-sectional view of the typical planar battery of FIG. 3(a) showing the headspace seal edging unfolded;

FIG. 3(c) is a partial cross-sectional view of the typical planar battery of FIG. 3(b) taken along the line 3-3;

FIGS. 4(a) and 4(b) are top plan views of a planar battery having a folded headspace seal according to the principles of the present invention;

FIG. 5 is a cross-sectional view of a planar battery having a folded headspace seal of the present invention; and

FIG. 6 is a cross-sectional view of a planar battery having a multiple cell stack therein.

### DETAILED DESCRIPTION OF THE PREFERRED EMBODIMENTS

The following description of the preferred embodiments is merely exemplary in nature and is in no way intended to limit the invention, its application, or uses. Thus, variations and modifications are contemplated, including, for example, folding a headspace seal at different angles as described in more detail herein.

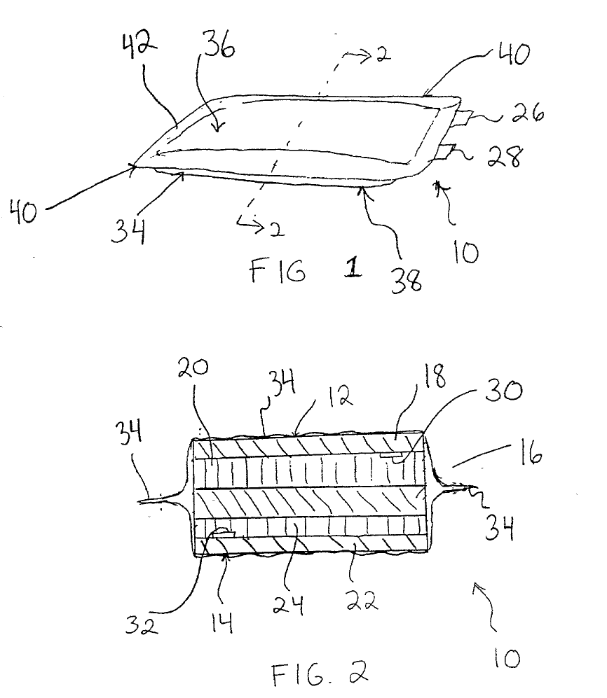

Electrochemical batteries, and specifically, planar batteries, such as multiplate lithium batteries, are used to power many smaller mobile electronic devices, such as, for example, PDAs, cellular telephones, pagers and laptop computers. These batteries are used in part because of their light weight and compact size, as well as their high energy level. Shown in exemplary form in FIG. 1 is a lithium ion battery 10 for use in a mobile electronic device wherein weight and thinness are important, such as, for example, a PDA or laptop computer.

A lithium ion battery 10 for powering a smaller mobile electronic device may be manufactured in various shapes and sizes, including, for example, about 103 mm in width by 103 mm in length, with a nominal thickness (i.e., height) of about 2 mm, and may provide a nominal capacity of 1450 mAh at more than 3.6 volts. Further, the nominal weight of such a lithium ion battery 10 may be about 43 grams. An example of a lithium ion battery 10 having these specifications and performance ratings is the Model 44 Series Lithium Ion Polymer Battery manufactured and sold by Valence Technology, Inc. It should be noted that other battery configurations are possible, including, for example, the narrow footprint Model 74 Series Polymer Batteries manufactured and sold by Valence Technology, Inc. The present invention may be implemented, for example, with these or any battery including a headspace with a flat edge seal.

As shown in FIG. 2, an electrochemical battery, such as the illustrated lithium ion battery 10 typically includes a negative electrode side 12 (“anode”), a positive electrode side 14 (“cathode”) and a separator 16 therebetween. The negative electrode side 12 includes a current collector 18, which is typically constructed of nickel, iron, stainless steel or copper foil, and a negative electrode active material 20. Negative electrode active materials 20 may include, for example, lithium, lithium alloys, such as, for example, alloys of lithium with aluminum, mercury, manganese, iron and zinc, to name a few.

The positive electrode side 14 includes a current collector 22, which is typically constructed of aluminum, nickel, iron, stainless steel, or copper, with a protective conducting coating foil over the surface of the current collector 22, and a positive electrode active material 24 that may be the same or different than the negative electrode active material 20. Positive electrode active materials 24 may include, for example, transition metal oxides, sulfides, selenides, and phosphates. Specifically, these materials may include oxides of cobalt, manganese, molybdenum and vanadium, sulfides of titanium, molybdenum and niobium, chromium oxides, copper oxides, lithiated oxides of cobalt, manganese and nickel, and lithiated phosphates of iron, cobalt, or molybdenum, to name a few.

The separator 16 is typically a solid electrolyte. A suitable electrolyte separator 16 may comprise, for example, a solid matrix containing an ionically conducting liquid with an alkali metal salt, with the liquid being an aprotic polar solvent, such as ethylene carbonate and dimethyl carbonate.

The component parts of the lithium ion battery 10 form a cell 11 and are assembled and packaged (i.e., sealed or encased) in an airtight packaging or casing 34 shown in FIG. 2 (e.g., flexible foil casing or housing) to prevent exposure to external elements. It should be noted that depending upon the specific application requirements, including, for example, power rating and charging capacity, more than one cell 11 may be assembled within a single packaging or casing 34 to provide a lithium ion battery 10 (e.g., stacked cell arrangement, bipolar arrays, and spirally wound long electrodes).

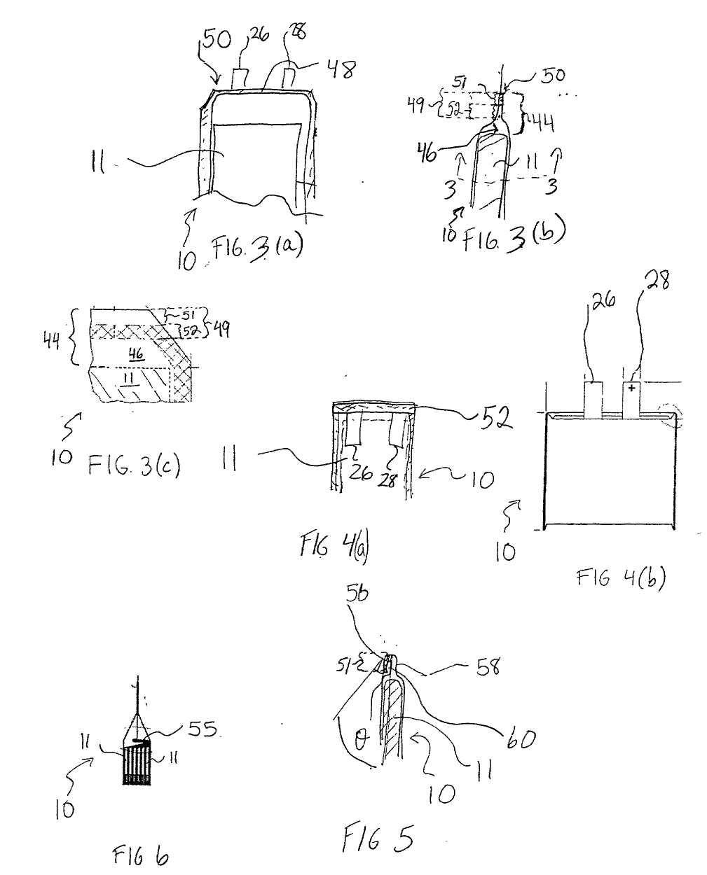

As shown in FIGS. 1 and 3(a)-(b), a planar battery such as a lithium ion battery 10 may be encased within a sachet-type flexible laminate packaging. The packaging or casing 34 typically includes a top surface 36 and a bottom surface 38 that are sealed at their edges 40 to provide an airtight environment for a cell 11 therein. The sealing arrangement forms an airtight perimeter portion 42 that extends generally outwardly from the top surface 36 and bottom surface 38.

As shown more clearly in FIG. 3(b), when encasing a lithium ion battery 10 within a sachet-type packaging, a headspace portion 44 is provided to guide the top surface 36 and bottom surface 38 material together and control their alignment. The headspace portion 44 results from bringing the two surfaces of package material together (i.e., top surface 36 and bottom surface 38), and provides volume to be used by internal battery connections. If the headspace portion 44 is too short, damage may result to these components (e.g., connections), as well as wrinkling of the package material, as it attempts to conform to the cell stack.

As shown in FIGS. 3(b) and 3(c), this headspace portion 44 includes unused volume 46 that may result from for example, packaging a cell 11 (i.e., cell 11 moves toward bottom of packaging) or for use in accommodating interconnections as described above, and a headspace seal 49 having an edge seal 51 and a seal flange 52. When a cell is made from a stack of multiple cells 11, the individual cells 11 must be connected together into a single electrical bus 55 as shown in FIG. 6. The connections must be provided for each of the positive and negative terminals, and this bussing requires a certain amount of height and volume. Generally, extra packaging material is collected at a top 50 of the battery as shown in FIG. 3(c), which forms the headspace portion 44.

In operation, and as shown in FIG. 2, the negative electrode side 12 of the lithium ion battery 10 is the anode during discharge, and the positive electrode side 14 is the cathode during discharge. Connection to the lithium ion battery 10 for powering external loads is provided using tabs or leads 26, 28, that may be connected thereto using, for example, hot welding, such as spot welding, or cold welding such as ultrasonic welding or friction welding. Further, a negative electrode side terminal 30 and a positive electrode side terminal 32 are provided as part of the lithium ion battery 10, and in combination with the tabs or leads 26, 28 provide power to the external loads (e.g., electronics of a cellular telephone).

Having described generally one type of planar battery (i.e., lithium ion battery 10) used for powering many smaller mobile devices and in connection with which the present invention may be implemented or constructed, the present invention provides a method of sealing the headspace portion 44 of a planar battery, such as, for example, a lithium ion battery 10 to reduce unused volume and decrease overall battery length.

Specifically, the packaging or casing 34 is configured such that the headspace seal 49 (i.e., edge seal 51 and seal flange 52) provided at the headspace portion 44 is folded as shown in FIGS. 4(a)-(b) and 5. Seal flanges 52 are formed using, for example, heat sealing, impulse heat sealing, or by ultrasonic sealing. Preferably, the headspace portion 44 is folded immediately below the seal flange 52 as shown in FIG. 3(b). The fold is a “dead fold”, such that the packaging material is permanently deformed, so that it resists unfolding. In general, the headspace portion 44 may be folded at any acute angle (θ) in order to reduce the overall dimensions of a packaged battery, including that area occupied by the unused volume 46 of the headspace portion 44, with a top portion 56 folded generally downwardly toward a bottom portion 58.

The fold may be formed using, for example, a mechanical brake, which creates the “dead-fold”. A mechanical brake bends material about a tight fulcrum, which deforms the material above its yield stress point, so that the deformation is permanent. Typically, the smaller the bend radius, the sooner the material will reach its yield point. It should be noted that more than one brake step may be used in order to create the acute angle. A gap 60 may be provided if the top portion 56 and bottom portion 58 are not folded onto and adjacent each other, preferably within the top and bottom surfaces 36, 38. It should be noted that the tabs or leads 26, 28 are also folded in connection with the seal flange 52, but may be folded back again in the opposite direction depending upon the particular application (e.g., if leads 26, 28 need to extend outward from the cell 11) as shown in FIG. 4(b). The foil is preferably fabricated with an outside insulating layer (e.g., PET or Nylon) to prevent shorting to the foil.

The overall length of a laminar battery, such as a lithium ion battery 10 is decreased, which preferably may be about 3 mm or more, and depending upon the battery type, preferably more than by about 5 mm. It should be noted that the headspace potion 44 may be tapered due to the sealing of the top and bottom surfaces 36, 38 together, and allows for the seal flange 52 to be folded against the top 50 of the battery.

Thus, the present invention provides a method of sealing a planar battery having a sachet-type packaging using a folded headspace seal flange. Unused battery volume is reduced and overall battery length decreased.

Although the present invention has been described in connection with sealing a lithium ion battery using a particular seal flange, it is not so limited, and the present invention may be provided to seal any type of laminar battery having one or more cells. Further, other types of folds may be made according to the principles of the present invention. Also, the seal flange may be configured differently depending upon the particular battery application and packaging requirements. The fold of the present invention may be performed along any edge of a packaged battery.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of folding a battery packaging having a headspace seal formed when sealing a battery therein, the method comprising the step of:
folding the headspace seal of a headspace portion of the battery packaging, the headspace seal folded generally at the middle of the headspace portion.

2. The method according to claim 1 wherein the battery is a lithium ion battery.

3. The method according to claim 1 wherein the battery packaging is a sachet packaging.

4. The method according to claim 3 wherein the battery packaging comprises a foil material.

5. The method according to claim 1 wherein the step of folding comprises folding the headspace seal onto itself.

6. The method according to claim 1 wherein the step of folding comprises folding the headspace seal at an acute angle relative to a top of the battery.

7. The method according to claim 1 wherein the step of folding comprises folding the headspace portion about in half.

8. A method of sealing a battery within a sachet packaging with a headspace portion, the method comprising the step of:
folding a headspace seal of the headspace portion extending from a top of the sachet packaging at an acute angle relative to a top of the battery.

9. The method according to claim 8 wherein the step of folding is performed at about the middle of the headspace portion.

10. The method according to claim 9 wherein the step of folding further comprises folding the headspace portion about in half.

11. The method according to claim 8 wherein the sachet packaging comprises a foil material.

12. A battery having a sachet packaging, the battery comprising:
a cell within the sachet packaging for providing power to an external load; and
a top portion of the sachet packaging having a headspace seal folded at an acute angle relative to the top portion.

13. The battery according to claim 12 wherein the cell comprises a lithium ion polymer cell.

14. The battery according to claim 12 wherein the folded headspace seal is folded at about the middle of the headspace portion with a top portion of the headspace seal folded generally adjacent to a bottom portion of the headspace seal.

15. The battery according to claim 12 wherein the top portion is tapered and the folded headspace seal is generally folded adjacent to a top of the battery.

16. An improved sealing arrangement for a planar battery having a sachet packaging, the improvement comprising:
a folded seal portion at a headspace portion of the planar battery, the folded seal portion configured at a generally acute angle relative to a top of the planar battery.

17. The improved sealing arrangement according to claim 16 wherein the folded seal portion comprises a headspace seal folded about in half against itself.

18. The improved sealing arrangement according to claim 16 wherein the planar battery comprises a lithium ion cell.

19. The improved sealing arrangement according to claim 16 wherein the folded seal portion is adjacent the top of the planar battery.
